(19) United States
(12) Patent Application Publication
(10) Pub. No.: US 2024/0305222 A1
(43) Pub. Date: Sep. 12, 2024

(54) DRIVING DEVICE, OPTICAL-ELEMENT DRIVING DEVICE, CAMERA MODULE, AND CAMERA-MOUNTED DEVICE

(71) Applicants: Shun SUZUKI, Tokyo (JP); Tomohiko OSAKA, Tokyo (JP)

(72) Inventors: Shun SUZUKI, Tokyo (JP); Tomohiko OSAKA, Tokyo (JP)

(73) Assignee: MITSUMI ELECTRIC CO., LTD., Tokyo (JP)

(21) Appl. No.: 18/598,017

(22) Filed: Mar. 7, 2024

(30) Foreign Application Priority Data
Mar. 10, 2023 (JP) 2023-037608

(51) Int. Cl. H02N 2/04; G03B 3/10; G03B 5/00; G03B 17/12

(52) U.S. Cl. CPC H02N 2/04; G03B 3/10; G03B 5/00; G03B 17/12; G03B 2205/0061

(57) ABSTRACT

A driving device includes a piezoelectric element that vibrates under application of a voltage, a resonance part that resonates with a vibration of the piezoelectric element and moves a moving member into contact the resonance part, and a conductive resin that fixes the piezoelectric element to the resonance part, in which the resonance part includes an accommodating portion capable of accommodating the conductive resin.

### CROSS REFERENCE TO RELATED APPLICATIONS

This application is entitled to (or claims) the benefit of Japanese Patent Application No. 2023-37608, filed on Mar. 10, 2023, the disclosure of which including the specification, drawings and abstract is incorporated herein by reference in its entirety.

### TECHNICAL FIELD

The present invention relates to a driving device, an optical element driving device, a camera module, and a camera-mounted device.

### BACKGROUND ART

For a camera module mounted on a camera-mounted device such as a smartphone or a drone, a driving device such as an ultrasonic motor using a piezoelectric element has been proposed as a driving device for driving an optical element.

For example, Patent Literature (hereinafter, referred to as “PTL”) 1 discloses a driving device in which an active element includes a resonance device (resonance part) and a piezoelectric element that vibrates the resonance device, and the active element drives a passive element by a vibrational operation. In the driving device disclosed in PTL 1, the piezoelectric element and the resonance device are bonded to each other by a conductive adhesive including a conductive material such as a metal ball.

### CITATION LIST

### Patent Literature

PTL 1: Japanese Unexamined Patent Application Publication (Translation of PCT Application) No. 2008-503995

### SUMMARY OF INVENTION

### Technical Problem

As disclosed in PTL 1, the piezoelectric element and the resonance device are bonded to each other by the conductive adhesive including the conductive material. Since this conductive adhesive contains the conductive material, the constituent particles tend to be larger than the particles of a non-conductive adhesive. Therefore, it is difficult to reduce the thickness between the piezoelectric element and the resonance device. The thickness between the piezoelectric element and the resonance device affects the vibration transmission between the piezoelectric element and the resonance device. When the thickness between the piezoelectric element and the resonance device increases, it is difficult to efficiently transmit the vibration from the piezoelectric element to the resonance device.

An object of the present invention is to provide a driving device, an optical element driving device, a camera module, and a camera-mounted device capable of efficiently transmitting vibration from a piezoelectric element to a resonance part.

### Solution to Problem

In order to achieve the above object, a driving device according to the present invention includes:
a piezoelectric element that vibrates under application of a voltage,
a resonance part that resonates with a vibration of the piezoelectric element and moves a moving member in contact with the resonance part; and
a conductive resin that fixes the piezoelectric element to the resonance part, in which
the resonance part includes an accommodating portion capable of accommodating the conductive resin.

In order to achieve the above object, an optical element driving device according to the present invention includes:
a holding part capable of holding an optical element;
a base part that accommodates the holding part such that the holding part is movable in an optical-path direction of the optical element; and
the driving device that drives the holding part.

In order to achieve the above object, a camera module according to the present invention includes:
the optical element driving device; and
an image capturing part configured to capture a subject image using the optical element.

In order to achieve the above object, a camera-mounted device according to the present invention is a camera-mounted device that is an information device or a transporting device, the camera-mounted device including:
the camera module; and
an image processing part configured to process image information obtained by the camera module.

### Advantageous Effects of Invention

According to the present invention, it is possible to efficiently transmit vibration from the piezoelectric element to the resonance part.

### BRIEF DESCRIPTION OF DRAWINGS

FIG. 1A is a front view of a smartphone in which a camera module according to an embodiment of the present disclosure is mounted;

FIG. 1B is a rear view of the smart phone illustrated in FIG. 1A;

FIG. 2 is a perspective view illustrating a camera module and an image capturing part;

FIG. 3 is a plan view of an optical element driving device main body included in an optical element driving device of the camera module;

FIG. 4 illustrates a resonance part being a component of a driving part of the optical element driving device main body illustrated in FIG. 3;

FIG. 5 illustrates the resonance part illustrated in FIG. 4 to which a piezoelectric element is attached;

FIG. 6 is a perspective view of the piezoelectric element and the resonance part illustrated in FIG. 5;

FIG. 7 is a perspective view illustrating the driving part illustrated in FIG. 3;

FIG. 8 is a side view illustrating the driving part illustrated in FIG. 7;

FIG. 9A is a front view illustrating an automobile as a camera-mounted device in which an in-vehicle camera module is mounted; and

FIG. 9B is a perspective view of the automobile illustrated in FIG. 9A as seen from obliquely rearward.

### DESCRIPTION OF EMBODIMENTS

Hereinafter, an embodiment of the present invention will be described in detail with reference to the accompanying drawings.

### [Smartphone]

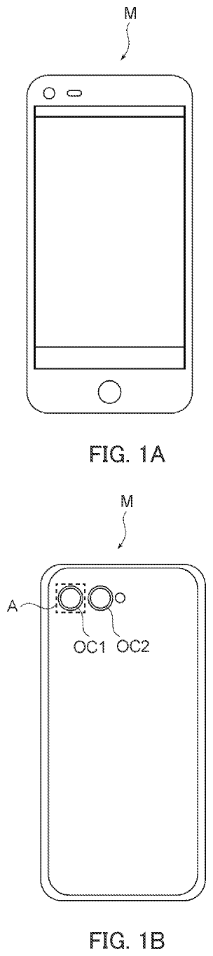

FIGS. 1A and 1B illustrate smartphone M (one example of a camera-mounted device) in which camera module A according to the present embodiment is mounted. FIG. 1A is a front view of smartphone M and FIG. 1B is a rear view of smartphone M.

Smartphone M includes a dual camera including two rear cameras OC1 and OC2. In the present embodiment, camera module A is applied to rear cameras OC1 and OC2.

Camera module A has an AF function and can automatically perform focusing at the time of capturing an image of a subject. Camera module A may have a shake correction function (hereinafter referred to as “Optical Image Stabilization (OIS) function). The OIS function allows image capturing without image blur by optically correcting shake (vibration) generated during image capturing.

### [Camera Module]

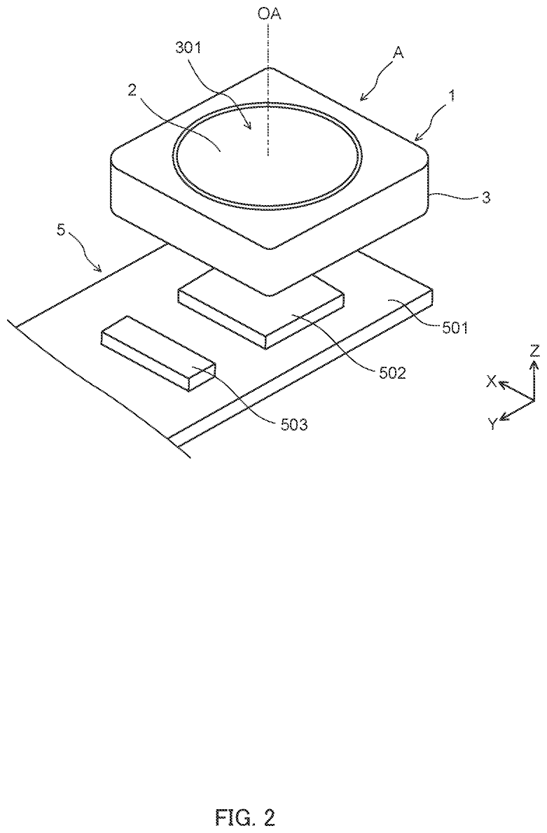

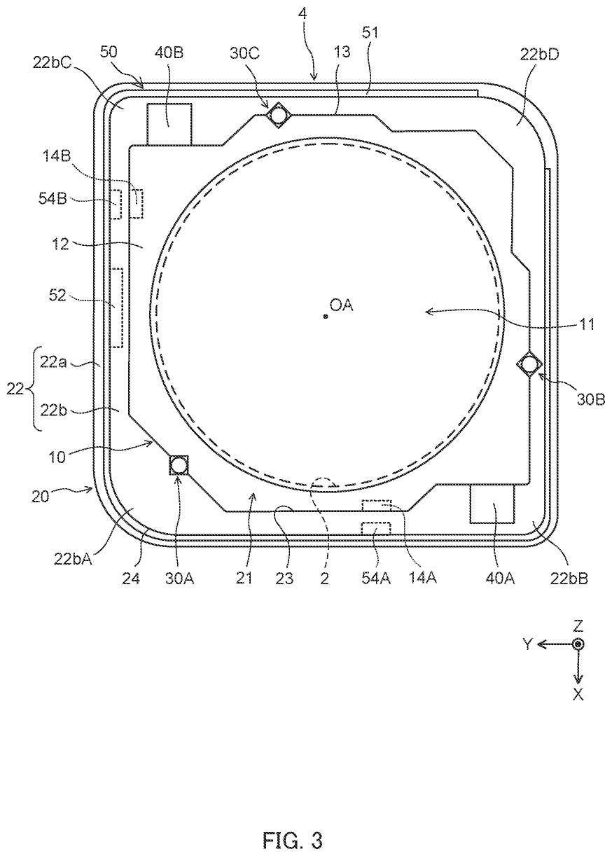

FIG. 2 is a perspective view illustrating camera module A and image capturing part 5. FIG. 3 is a plan view of optical element driving device main body 4 included in optical element driving device 1 of camera module A illustrated in FIG. 2. As illustrated in FIGS. 2 and 3, the present embodiment will be described using a Cartesian coordinate system (X, Y, Z). The same orthogonal coordinate system (X, Y, Z) is also used for illustration of below-mentioned figures.

By way of example, camera module A is mounted such that the vertical direction (or horizontal direction) is the X-direction, the horizontal direction (or vertical direction) is the Y-direction, and the front-rear direction is the Z-direction, for example, during capturing an image with smartphone M. That is, the Z-direction is the optical-axis direction of optical axis OA of lens part 2 illustrated in FIG. 2, and in FIG. 2, the upper side (+Z side) in the figure is the light reception side in the optical-axis direction, and the lower side (−Z side) is the image formation side in the optical-axis direction.

Note that, while below descriptions will be given with reference to optical axis OA, the optical-axis direction in optical axis OA may also be replaced with an optical-path direction and a focus direction (a direction in which the focus is adjusted) depending on the type of an optical element. Here, a path of light formed by opening portion 301 of cover 3 to be described later, opening portion 11 of holding part 10 to be described later, or accommodation opening portion 21 of base part 20 to be described later is an optical path. A direction in which the optical path extends (a direction extending through the opening portions) is the optical-path direction.

As illustrated in FIGS. 2 and 3, camera module A includes: optical element driving device 1 that implements the AF function; lens part 2 composed of a cylindrical lens barrel and a lens housed therein; and image capturing part 5 configured to capture a subject image imaged by lens part 2. That is, optical element driving device 1 is a so-called lens driving device that drives lens part 2 as an optical element.

Optical element driving device 1 of the present embodiment has a configuration in which the length in the Z-direction is shorter than the lengths in the X-direction and the Y-direction in consideration of mounting on camera module A and the like described above, and has a configuration in which the height is reduced when the Z-direction is the height direction.

### [Cover]

In optical element driving device 1, an outer side of optical element driving device main body 4 is covered with cover 3. Cover 3 is a capped quadrangular tubular body having a substantially rectangular shape in plan view seen in the Z-direction. In the present embodiment, cover 3 has a substantially square shape in plan view. Cover 3 has substantially circular opening portion 301 in its upper surface. Lens part 2 is accommodated in opening portion 11 of holding part 10 of optical element driving device main body 4, faces the outside from opening portion 301 of cover 3, and is configured to protrude toward the light reception side from the opening surface of cover 3 in accordance with the movement in the Z-direction. The inner wall of cover 3 is fixed to base part 20 (for example, bottom portion 22a to be described later) of optical element driving device main body 4 by, for example, adhesive, and accommodates optical element driving device main body 4.

Cover 3 includes a member that blocks electromagnetic waves from the outside of optical element driving device 1 and from the inside of cover 3, for example, a shield member made of a magnetic material.

### [Image Capturing Part]

Image capturing part 5 is disposed on the image formation side of optical element driving device 1. Image capturing part 5 includes, for example, image sensor board 501, image capturing element 502, and control part 503 mounted on image sensor board 501. Image capturing element 502 is composed of, for example, a Charge-Coupled Device (CCD) image sensor, a Complementary Metal Oxide Semiconductor (CMOS) image sensor, or the like, and captures a subject image imaged by lens part 2.

Control part 503 is composed, for example, of a control IC, and performs a drive control of optical element driving device 1. Optical element driving device 1 is mounted on image sensor board 501 and is mechanically and electrically connected to the image sensor board. Control part 503 may be disposed on image sensor board 501 or may be disposed on a camera-mounted apparatus (smartphone M in the present embodiment) on which camera module A is mounted.

In FIG. 2, lens part 2 is driven in the Z-direction by optical element driving device 1 with respect to image sensor board 501 whose position is fixed, so that the subject image is formed on image capturing element 502, but image capturing element 502 may, for example, be driven in the Z-direction. In this case, lens part 2 may be fixed to cover 3, and image capturing element 502, which is an optical element, may be driven in the Z-direction by optical element driving device 1 to form the subject image on image capturing element 502.

### [Optical Element Driving Device Main Body]

Optical element driving device main body 4 is a main body portion of optical element driving device 1 that drives lens part 2, which is an optical element, in the Z-direction. For convenience of explanation, the following description is based on the premise that optical element driving device 1 drives lens part 2. However, as described above, optical element driving device 1 may drive image capturing element 502.

As illustrated in FIG. 3, optical element driving device main body 4 includes holding part 10, base part 20, supporting parts 30A, 30B, and 30C, driving part 40A and 40B, board part 50, and the like.

### [Holding Part]

Holding part 10 includes frame portion 12 in which opening portion 11 is formed at the central portion of the frame portion, and opening portion 11 is configured to hold lens part 2 inside. For example, in opening portion 11, a mounting groove or the like is formed in the inner circumferential surface of the opening portion. Accordingly, opening portion 11 is configured to be capable of holding lens part 2 on the inner circumferential surface. As described above, holding part 10 surrounds the outer circumference of lens part 2 to hold lens part 2.

Outer circumferential surface 13, which is the outer circumferential side of frame portion 12, is supported at a plurality of places (in FIG. 3, for example, three places) by supporting parts 30A, 30B, and 30C extending along the Z-direction such that movement in the Z-direction is possible.

Outer circumferential surface 13 is held by driving parts 40A and 40B at a plurality of places (two places in FIG. 3, for example), and holding part 10 is movable in the Z-direction by driving parts 40A and 40B.

Further, outer circumferential surface 13 is, at the plurality of places (in FIG. 3, for example, two places), provided with magnets 14A and 14B for detecting the Z-direction position. Position detection sensors 54A and 54B to be described later are disposed to face magnets 14A and 14B, respectively.

Opening portion 11 is formed in a cylindrical shape to correspond to cylindrical lens part 2, but it is possible to alter its shape to an appropriate shape corresponding to the shape of lens part 2.

In addition, when optical element driving device 1 drives image capturing element 502, opening portion 11 does not have to be disposed in holding part 10. That is, holding part 10 does not have to be the frame portion, and in that case, image capturing element 502 may be held on the upper surface (the surface on the light reception side) of holding part 10, for example.

### [Base Part]

Base part 20 includes frame portion 22 in which accommodation opening portion 21 is formed at the central portion of the frame portion. Accommodation opening portion 21 is configured to surround the outer circumference of holding part 10 so that holding part 10 is accommodable inside.

Supporting parts 30A, 30B, and 30C are disposed at a plurality of places on inner circumferential surface 23, which is the inner side of accommodation opening portion 21. Base part 20 supports holding part 10 by supporting parts 30A, 30B, and 30C such that holding part 10 is movable in the Z-direction.

Driving parts 40A and 40B are disposed on inner circumferential surface 23 at a plurality of places. Driving parts 40A and 40B disposed on base part 20 moves holding part 10 in the Z-direction. Holding part 10 functions as a movable part driven by driving parts 40A and 40B, and base part 20 functions as a fixing part with respect to holding part 10.

In plan view, inner circumferential surface 23 is formed to correspond to the shape of outer circumferential surface 13 of holding part 10. In FIG. 3, the shapes of outer circumferential surface 13 of holding part 10 and inner circumferential surface 23 of accommodation opening portion 21 are exemplary shapes, and can be appropriately changed depending on, for example, the arrangement of supporting parts 30A, 30B, and 30C and driving parts 40A and 40B.

Frame portion 22 includes bottom portion 22a and sidewall portion 22b. The inner wall of cover 3 is fixed to bottom portion 22a by, for example, adhesive. Board part 50 is attached to outer circumferential surface 24, which is the outer circumferential side of sidewall portion 22b, along outer circumferential surface 24.

### [Supporting Part]

Supporting parts 30A, 30B, and 30C supports holding part 10 such that holding part 10 is movable in the Z-direction with respect to base part 20. As illustrated in FIG. 3, supporting parts 30A, 30B, and 30C are disposed on inner circumferential surface 23 circumferential (outer surface 13) at three circumferentially distributed places, respectively.

Although not illustrated in detail, each of supporting parts 30A, 30B, and 30C includes: a first groove portion disposed in outer circumferential surface 13 of holding part 10; a second groove portion disposed in inner circumferential surface 23 of base part 20; and a rolling member (for example, a ball member or the like) that is sandwiched between the first groove portion and the second groove portion and is capable of rolling therebetween.

In supporting parts 30A, 30B, and 30C, the first groove portion and the second groove portion extend in the Z-direction and are disposed to face each other. The rolling member is rollably sandwiched between the first groove portion and the second groove portion as described above.

One or more rolling members are disposed between the first groove portion and the second groove portion. When a plurality of rolling members are disposed between the first groove portion and the second groove portion, the inclination (tilt) of holding part 10 can be suppressed more stably. In this case, the plurality of rolling members are held by a retainer (not illustrated) such that the rolling members are disposed to align with one another along the Z-direction and such that the distances between the rolling members can be kept constant and the rolling members can be positioned in the Z-direction.

Supporting parts 30A, 30B, and 30C configured as described above support holding part 10 such that holding part 10 is movable in the Z-direction with respect to base part 20.

Note that the first groove portion and the second groove portion may be formed of a metal material or the like, and a rail-shaped member capable of rolling the rolling members may be attached to the first and the second grooves. Holding part 10 and base part 20 are usually formed of resin or the like, and the rolling members are usually formed of a material such as ceramic or alloy. Thus, when the rail-shaped member formed of a metal material or the like harder than holding part 10 and base part 20 is disposed on the first groove portion and the second groove portion, it is made unlikely for the first groove portion and the second groove portion to be deformed even when a pressing force is applied from the rolling members. With such a configuration, supporting parts 30A, 30B, and 30C are capable of stably supporting holding part 10 such that holding part 10 is movable in the Z-direction.

### [Driving Part]

Driving parts 40A and 40B drive holding part 10 in the Z-direction with respect to base part 20. As illustrated in FIG. 3, driving parts 40A and 40B are disposed on inner circumferential surface 23 (outer circumferential surface 13) at two circumferentially distributed places. Optical element driving device main body 4 is capable of driving holding part 10 and lens part 2 together in the Z-direction by above-described supporting parts 30A, 30B, and 30C and driving parts 40A and 40B, thereby achieving the AF function.

As illustrated in FIG. 3, frame portion 22 of base part 20 includes four corner portions 22bA, 22bB, 22bC, and 22bD. In the example illustrated in FIG. 3, supporting part 30A is disposed at corner portion 22bA. Accordingly, driving parts 40A and 40B are disposed respectively at corner portions 22bB and 22bC at positions which are different from corner portion 22bA and is point-symmetric with respect to optical axis OA in plan view. With this arrangement, even when the weight of the optical element such as lens part 2 increases, holding part 10 can be moved stably.

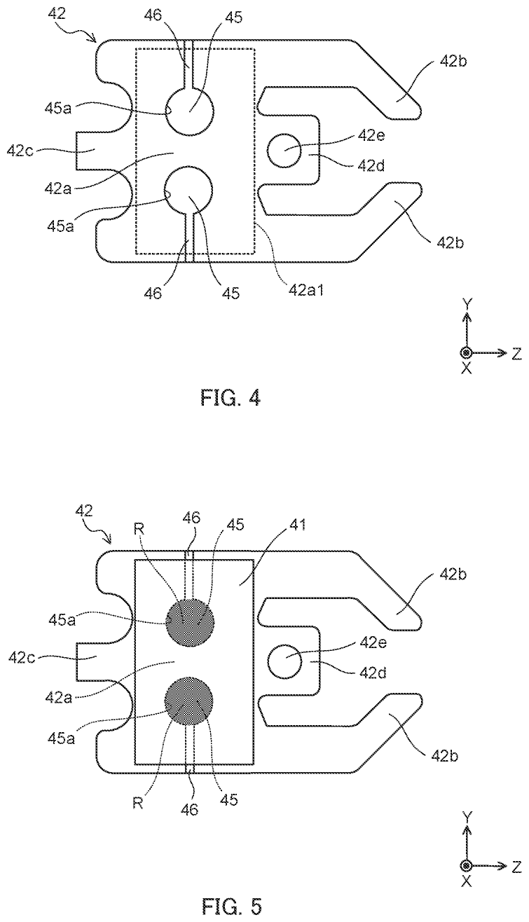

As driving parts 40A and 40B, an ultrasonic motor, which is an actuator including piezoelectric elements, is used. Driving parts 40A and 40B will be described with reference to FIGS. 4 to 8.

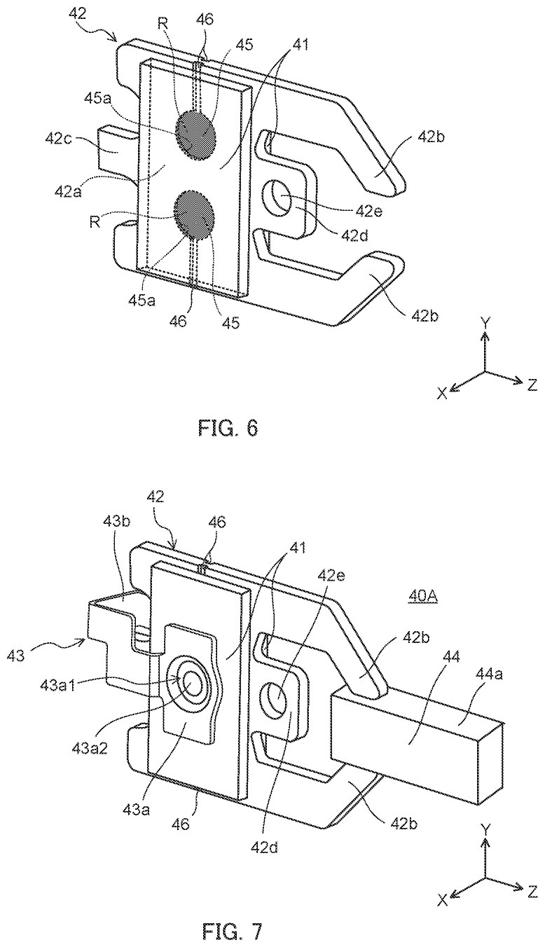

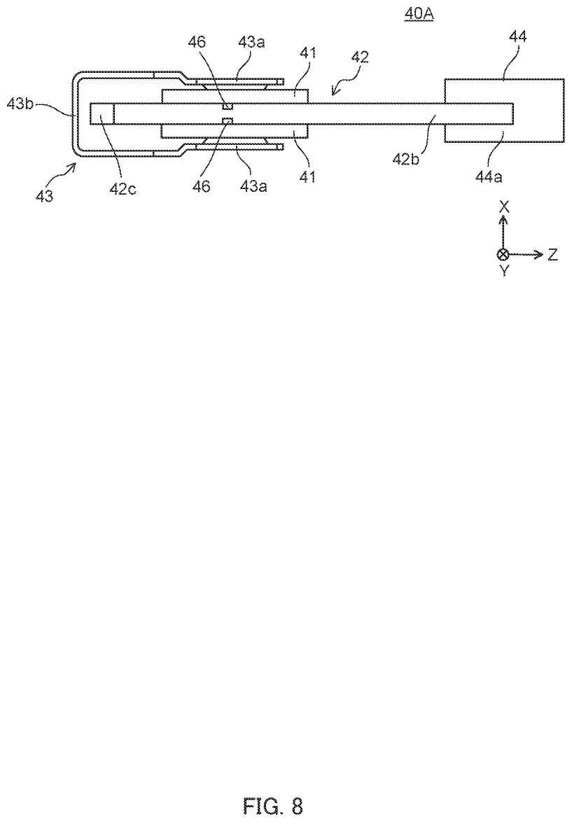

FIG. 4 illustrates resonance part 42 being a component of driving part 40A of optical element driving device main body 4 illustrated in FIG. 3. FIG. 5 illustrates resonance part 42 illustrated in FIG. 4 to which piezoelectric elements 41 are attached. FIG. 6 is a perspective view of piezoelectric element 41 and resonance part 42 illustrated in FIG. 5. FIG. 7 is a perspective view illustrating driving part 40A illustrated in FIG. 3. FIG. 8 is a side view illustrating driving part 40A illustrated in FIG. 7. FIGS. 4 to 8 illustrate driving part 40A. Driving part 40B has the same configuration as driving part 40A, and detailed illustration and explanation thereof are thus omitted.

Driving part 40A includes piezoelectric elements 41, resonance part 42, electrode part 43, power transmission part 44 (a moving member in the present disclosure), and the like. A driving force generated by resonance part 42 in resonance with the vibration of piezoelectric elements 41 is transmitted to power transmission part 44. Here, although not illustrated, power transmission part 44 is fixed to holding part 10 side, and the driving force generated by resonance part 42 is transmitted to holding part 10 via power transmission part 44. In driving part 40A, resonance part 42 serves as an active element, and power transmission part 44 serves as a passive element.

Piezoelectric elements 41 are, for example, plate-shaped elements formed from a ceramic material, and generates vibration when a high-frequency voltage is applied. Two piezoelectric elements 41 are disposed to sandwich body portion 42a of resonance part 42 therebetween. Although not illustrated, interconnections disposed on FPC 51 to be described later are electrically connected to piezoelectric elements 41 via electrode part 43 to be described later, and are configured to apply a voltage to piezoelectric elements 41.

Resonance part 42 is formed of a plate member made of a conductive material, resonates with vibration of piezoelectric elements 41, converts a vibrational motion into a linear motion, and moves power transmission part 44 that comes into contact therewith. Resonant portion 42 is formed, for example, by laser processing, etching processing, press working, or the like of a metal plate.

Resonance part 42 includes body portion 42a, a pair of arm portions 42b, energization portion 42c, protruding portion 42d, and the like.

Body portion 42a is a substantially rectangular portion to which two piezoelectric elements 41 are bonded at the front and back surfaces. The vibration generated by piezoelectric elements 41 are transmitted to the pair of arm portions 42b via body portion 42a.

The pair of arm portions 42b extend in the +Z-direction from opposite side portions of body portion 42a to distal end portions that are free ends of arm portions 42b. The pair of arm portions 42b have symmetrical shapes, and are symmetrically deformed by resonating with the vibration of piezoelectric elements 41. The pair of arm portions 42b are formed such that their free ends sandwich power transmission part 44. More specifically, the pair of arm portions 42b are configured such that their free ends come into contact with contact surfaces 44a of power transmission part 44, which will be described later, toward the inside of power transmission part 44.

Energization portion 42c extends in the −Z-direction from body portion 42a and is disposed at an end portion of resonance part 42. Energization portion 42c is a portion forming a power supply line to piezoelectric elements 41 via body portion 42a, and the interconnections disposed on FPC 51 are electrically connected to energization portion 42c, although not illustrated.

Protruding portion 42d extends in the +Z-direction from body portion 42a and is disposed at a position close to the center of resonance part 42. Through-hole 42e through which a rivet or the like is inserted is formed in protruding portion 42d. Protruding portion 42d is fixed to base part 20 by using the rivet or the like inserted through the through-hole 42e.

Electrode part 43 includes a pair of terminal portions 43a and coupling portion 43b coupling together the pair of terminal portions 43a. The pair of terminal portions 43a are connected to the outer surfaces of two electrically piezoelectric elements 41, respectively. Electrode part 43 is a part forming the power supply line to piezoelectric elements 41, and the interconnections disposed on FPC 51 are electrically connected to electrode part 43, although not illustrated.

In electrode part 43, each of terminal portions 43a includes recessed portion 43a1 formed at the central portion of terminal portion 43a and through-hole 43a2 formed in the central portion of recessed portion 43a1. Terminal portion 43a is electrically connected to the outer surface of piezoelectric element 41 by solder. The solder is melted and cured in recessed portion 43a1 to electrically connect terminal portion 43a to the outer surface of piezoelectric element 41 via through-hole 43a2. The melting of the solder can be performed in a short time by, for example, a laser. It is thus possible to suppress thermal influence on piezoelectric element 41 and a conductive resin to be described later.

Note that terminal portion 43a may be electrically connected to the outer surface of piezoelectric element 41 by the below-described conductive resin or the like instead of the solder.

Electrical connection between energization portion 42c and electrode part 43 generates vibration when a voltage is applied to piezoelectric elements 41 bonded to body portion 42a. Resonance part 42 has at least two resonance frequencies and deforms in behaviors different between the resonant frequencies. In other words, the entire shape of resonant part 42 is set such that resonance part 42 deforms in behaviors different between the two resonant frequencies.

Here, the different behaviors include a behavior causing the pair of arm portions 42b to move forward power transmission part 44 in the Z-direction and a behavior causing the arm portions to move backward the power transmission part. Therefore, vibrating resonance part 42 at a desired resonant frequency makes it possible for the pair of arm portions 42b to move power transmission part 44 forward or backward in the Z-direction.

Power transmission part 44 has, for example, a rectangular parallelepiped shape having a predetermined length in the Z-direction, and includes, at portions facing the pair of arm portions 42b, contact surfaces 44a coming into contact with arm portions 42b. As described above, the pair of arm portions 42b are configured to make contact with contact surfaces 44a, and power transmission part 44 functions as a chucking guide with respect to the pair of arm portions 42b. For example, an end portion of power transmission part 44 on the right side (+Z side) in the figure is attached to outer circumferential surface 13 of frame portion 12 of holding part 10.

Piezoelectric elements 41 are bonded to body portion 42a using an adhesive. A conductive adhesive is used for electrically connecting piezoelectric elements 41 to resonance part 42. As the conductive adhesive, a conductive resin such as a silver epoxy or an epoxy containing a metal ball is usable, for example.

Since the conductive adhesive contains silver particles, metal balls, or the like, the constituent particles are larger. It is thus difficult reduce the thickness between piezoelectric elements 41 and resonance part 42 as compared with a non-conductive adhesive. Since the thickness between piezoelectric elements 41 and resonance part 42 affects the vibration transmission between piezoelectric elements 41 and resonance part 42, it is desirable to reduce the thickness as much as possible.

Therefore, in the present embodiment, accommodating portions 45 are formed in body portion 42a. Each of accommodating portions 45 is a recessed portion or a through-hole formed in body portion 42a to which piezoelectric elements 41 are bonded. By way of example, accommodating portion 45 is a recessed portion in the present embodiment. Further, by way of example, in plan view of resonance part 42 and piezoelectric elements 41, accommodating portions 45 on the inner surface side of piezoelectric elements 41 are disposed at different positions from positions where terminal portions 43a are connected to the outer surfaces of piezoelectric elements 41. In addition, accommodating portions 45 are filled with conductive resin R, which is a conductive adhesive, so as to accommodate conductive resin R.

Accommodating portions 45 are filled with conductive resin R and piezoelectric elements 41 and resonance part 42 are bonded to each other for fixation. It is thus possible to reduce the thickness between piezoelectric elements 41 and resonance part 42 even when bonding is performed using conductive resin R having a relatively large constituent particles.

Further, in body portion 42a, piezoelectric elements 41 are bonded to body portion 42a by applying a non-conductive adhesive to region 42a1 other than accommodating portions 45. The non-conductive adhesive is thus applied to region 42al except for accommodating portions 45. It is thus possible to reduce the thickness between piezoelectric elements 41 and resonance part 42.

When conductive resin R and the non-conductive adhesive are used, conductive resin R and the non-conductive adhesive may be cured at the same time or may be cured separately depending on the shape and structure of piezoelectric elements 41 and resonance part 42. After the inner surfaces of piezoelectric elements 41 are fixed to resonance part 42 as described above, terminal portions 43a of electrode part 43 are electrically connected by solder to the outer surfaces of piezoelectric element 41 facing away from the inner surfaces.

Piezoelectric elements 41 are bonded to body portion 42a as described above. It is thus possible to reduce the thickness between piezoelectric elements 41 and resonance part 42. The transmission efficiency of vibration from piezoelectric elements 41 to resonance part 42 increases as the thickness between piezoelectric element 41 and resonance part 42 decreases. Therefore, in the present embodiment in which conductive resin R is accommodated in accommodating portions 45, the vibration from piezoelectric elements 41 can be efficiently transmitted to resonance part 42.

Here, by way of example, two accommodating portions 45 are disposed in each of the opposite surfaces of resonance part 42. However, the number of accommodating portions 45 can be changed as appropriate. Further, inner circumferential surface 45a of each of accommodating portions 45 has a curved surface shape and has a circular shape in plan view, but the shape can also be changed as appropriate.

The number, shape, and the like of accommodating portions 45 can be changed as appropriate, and in every case, it is desirable that accommodating portions 45 be filled with conductive resin R over the entire area thereof. If air remains in accommodating portions 45, the air may expand in accommodating portions 45 closed by piezoelectric elements 41 when conductive resin R is thermally cured. Accordingly, adhesion and electrical connection between piezoelectric elements 41 and resonance part 42 are hindered.

Therefore, in the present embodiment, body portion 42a is provided with communication portions 46 that communicate between accommodating portions 45 and the space outside the region of resonance part 42 to which piezoelectric elements 41 are fixed. Communication portions 46 are grooves extending from accommodating portions 45 to end portions of resonance part 42.

Communication portions 46 serve as an air escape path even if air remains in accommodating portions 45 and the air expands in accommodating portions 45 closed by piezoelectric elements 41 when conductive resin R is thermally cured. Therefore, conductive resin R can be thermally cured without hindering adhesion and electrical connection between piezoelectric elements 41 and resonance part 42. In the present embodiment, communication portions 46 extend to the end portions of resonance part 42 and are thus capable of reliably discharging the air from accommodating portions 45 to the outside even when the positions of fixation of piezoelectric elements 41 are displaced.

In addition, when the amount of conductive resin R injected into accommodating portions 45 is larger than the accommodation amount in accommodating portions 45, communication portions 46 guide excess conductive resin R to communication portions 46. In a case where communication portions 46 are not formed, there is a possibility that the thickness between piezoelectric elements 41 and resonance part 42 cannot be reduced if the amount of conductive resin R injected into accommodating portions 45 is larger than the above-described accommodation amount. Unlike this, communication portions 46 guide excess conductive resin R to communication portions 46. The accommodation amount of conductive resin R in accommodating portions 45 becomes an appropriate amount, and the thickness between piezoelectric elements 41 and resonance part 42 can be reduced.

Here, communication portions 46 extend from accommodating portions 45 to the end portions of resonance part 42. However, communication portions 46 do not have to extend to the end portions of resonance part 42 as long as communication with the space outside the region where piezoelectric elements 41 are fixed is possible, that is, as long as air can be discharged from accommodating portions 45 to the outside.

Further, if inner circumferential surfaces 45a as seen in plan view are shaped to have a corner portion, conductive resin R might spread while leaving a gap, and in that case, air remains in the gap. As described above, the air remaining in the gap might expand when conductive resin R is thermally cured, and might hinder adhesion and electrical connection between piezoelectric elements 41 and resonance part 42.

Therefore, in the present embodiment, in each of accommodating portions 45, inner circumferential surface 45a is formed to have a circular shape in plan view. Since inner circumferential surface 45a has a circular shape in plan view, injected conductive resin R spreads without leaving any gap and makes contact with inner circumferential surface 45a without remaining air. Consequently, accommodating portion 45 is filled with conductive resin R over the entire area thereof. Conductive resin R accommodated in accommodating portions 45 can thus ensures that adhesion and electrical connection between piezoelectric elements 41 and resonance part 42 are performed.

Note that the shape of accommodating portion 45 as seen in plan view does not have to be circular as long as conductive resin R to be injected is spreadable without leaving any gap, and may be, for example, an elliptical shape.

With the configuration described above, in driving parts 40A and 40B, the thickness between piezoelectric elements 41 and resonance part 42 can be reduced, and the vibration from piezoelectric elements 41 can be efficiently transmitted to resonance part 42.

When a voltage is applied to piezoelectric elements 41 of driving parts 40A and 40B, piezoelectric elements 41 vibrate, resonance part 42 deforms in a behavior corresponding to the frequency, and the pair of arm portions 42b also deform in a behavior corresponding to the frequency. The pair of arm portions 42b make contact with power transmission part 44 so as to push power transmission part 44 inward, a driving force generated by the deformation of the pair of arm portions 42b is transmitted to power transmission part 44, and power transmission part 44 is relatively moved in the Z-direction with respect to resonance part 42. Thus, driving forces of driving parts 40A and 40B are transmitted to holding part 10, whereby holding part 10 moves in the Z-direction, and focusing is performed.

### [Board Part]

Board part 50 includes circuitry for driving driving parts 40A and 40B. Board part 50 includes Flexible Printed Circuit (FPC) 51, driver IC 52, position detection sensors 54A and 54B, and the like.

FPC 51 is a flexible board, and is formed by laminating a thin insulating layer such as a resin film and a metal layer such as a copper foil on each other. Although not illustrated in the figures, the metal layer is formed as a circuit of signal lines and power supply lines, to which driving parts 40A and 40B, driver IC 52, position detection sensors 54A and 54B, and the like are electrically connected.

Driver IC 52 is an IC for controlling a drive signal for driving driving parts 40A and 40B. For example, driver IC 52 outputs the drive signal based on detection signals detected by position detection sensors 54A and 54B, and the output drive signal is output to driving parts 40A and 40B.

Position detection sensors 54A and 54B are, for example, a magnetic sensor such as a Hall element. Position detection sensors 54A and 54B detect the intensity of the magnetic force caused by magnets 14A and 14B disposed to face position detection sensors 54A and 54B. Thus, position detection sensors 54A and 54B acquire the relative position between holding part 10 and base part 20 in the Z-direction and output the relative position as a detection signal. Here, two position detection sensors 54A and 54B are disposed, but a single position detection sensor may be disposed, and in this case, a single magnet may be disposed to face the position detection sensor.

Although not illustrated, FPC 51 is provided with the interconnections electrically connected to driving parts 40A and 40B.

FPC 51 may include an inductor that boosts a voltage (input voltage) of a drive signal input from driver IC 52 and outputs the boosted voltage to driving parts 40A and 40B.

In order to mount above-described driver IC 52 and position detection sensors 54A and 54B on FPC 51, FPC 51 is a single long board. FPC 51 is disposed along outer circumferential surface 24 of frame portion 22 of base part 20 so as to follow substantially the whole course of outer circumferential surface 24.

In order to dispose FPC 51 along outer circumferential surface 24, for example, a portion of outer circumferential surface 24 at corner portion 22bA is formed in an arc shape in plan view. Accordingly, FPC 51 can be disposed in close contact with the portion of outer circumferential surface 24 at corner portion 22bA. Therefore, the size of cover 3 disposed on the outer side of FPC 51 does not need to be increased, and the whole device can be miniaturized and the cost can be reduced.

### [Variation 1]

By way of example, piezoelectric elements 41 are bonded to body portion 42a of resonance part 42 using conductive resin R and the non-conductive adhesive in the above-described embodiment. However, piezoelectric elements 41 may be bonded to body portion 42a using only conductive resin R without using the non-conductive adhesive.

Here, only conductive resin R is applied to piezoelectric elements 41 or body portion 42a, and piezoelectric elements 41 are pressed against body portion 42a or body portion 42a is pressed against piezoelectric elements 41. When a greater amount of conductive resin R than the amount required for adhesion is applied, excess conductive resin R can be accommodated in above-described accommodating portions 45. Thus, in above-described region 42al, the appropriate amount of conductive resin R is interposed between piezoelectric elements 41 and body portion 42a. It is thus possible to reduce the thickness between piezoelectric elements 41 and resonance part 42.

### Other Embodiments

It is not intended to limit the present invention to the above-mentioned preferred embodiment, but the present invention may be further modified within the scope and spirit of the invention defined by the appended claims.

For example, while smartphone M has been described in the embodiment as one example, the present invention is applicable to a camera-mounted device including a camera module and an image processing part that processes image information obtained by the camera module. The camera-mounted device encompasses an information device and a transporting device. Examples of the information device include a camera-mounted mobile phone, a note-type personal computer, a tablet terminal, a mobile game machine, a web camera, and a camera-mounted in-vehicle device (for example, a rear-view monitor device or a drive recorder device). In addition, examples of the transporting device include an automobile, drone, and/or the like.

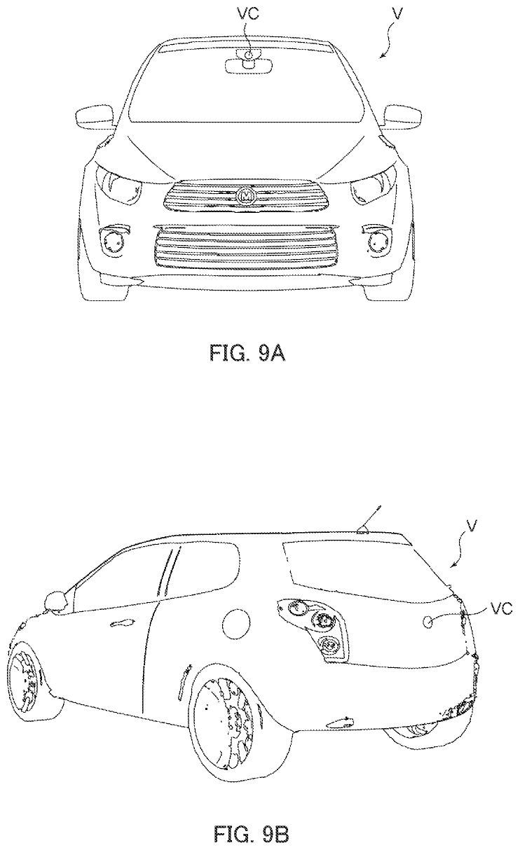

FIGS. 9A and 9B illustrate automobile V serving as the camera-mounted device in which in-vehicle camera module VC (Vehicle Camera) is mounted. FIG. 9A is a front view of automobile V and FIG. 9B is a rear perspective view of automobile V. Camera module A described in the above-described embodiment is mounted as in-vehicle camera module VC in automobile V. As illustrated in FIGS. 9A and 9B, in-vehicle camera module VC may, for example, be attached to the windshield so as to face forward, or to the rear gate so as to face backward. In-vehicle camera module VC is used for rear monitoring, drive recording, collision avoidance control, automatic drive control, and the like.

In addition, although the above-described embodiment has been described in relation to optical element driving device 1 that drives lens part 2 as an optical element, the optical element to be driven may be an optical element other than a lens, such as a mirror or a prism, or may be an optical element such as image capturing element 502. In this case, opening portion 11 of holding part 10 may be changed in shape depending on the shape of the optical element to be attached or may be eliminated in some cases.

In the above-described embodiment, optical element driving device 1 has an AF function, but may have not only the AF function but also a function of moving lens part 2 in the Z-direction, such as a zooming function.

Further, the above embodiment has been described in relation to optical element driving device 1 having the AF function by way of example. However, optical element driving device 1 may have an OIS function. When having the OIS function, optical element driving device 1 includes an another base part for supporting base part 20 such that base part 20 is movable in the X-direction and Y-direction via an OIS supporting part, and an OIS driving part for driving base part 20 in the X-direction and Y-direction with respect to the another base part. In this case, for example, a configuration may be employed in which above-described driving part 40A is used as the OIS driving part such that the OIS driving part drives base part 20 in the X-direction and the Y-direction.

Further, in the above-described embodiment, the free ends of the pair of arm portions 42b of resonance part 42 are configured to sandwich power transmission part 44. However, the present invention is not limited to this configuration, and other configurations may also be employed as long as resonance part 42 and power transmission part 44 are configured to make contact with each other. For example, the pair of arm portions 42b may be configured such that power transmission parts 44 are disposed on the outer side of the pair of arm portions 42b to correspond respectively to the pair of arm portions 42b, and the free ends of the pair of arm portions 42b make contact with power transmission parts 44 in the outward direction. Further, resonance part 42 may have a configuration in which resonance part 42 includes single arm portion 42b, and the free end of single arm portion 42b makes contact with power transmission part 44.

Further, in the above embodiment, resonance part 42 is fixed to the base part 20 side, and power transmission part 44 is fixed to the holding part 10 side. However, resonance part 42 may be fixed to the holding part 10 side, and power transmission part 44 may be fixed to the base part 20 side.

The embodiment of the present invention has been described above. It should be noted that the above description is illustrative of a preferred embodiment of the present invention, and the scope of the present invention is not limited thereto. That is, the configuration of the device and the shape of each part are merely an example, and it is obvious that modifications and additions to these examples various are possible within the scope of the present invention.

### INDUSTRIAL APPLICABILITY

The optical element driving device and the camera module according to the present invention are useful, for example, by being mounted on a camera-mounted device such as a smartphone, a mobile phone, a digital camera, a notebook personal computer, a tablet terminal, a portable game machine, an in-vehicle camera, and a drone.

### REFERENCE SIGNS LIST

1 Optical element driving device
2 Lens part
3 Cover
4 Optical element driving device main body
5 Image capturing part
10 Holding part
11 Opening portion
12 Frame portion
13 Outer circumferential surface
14A, 14B Magnet
20 Base part
21 Accommodation opening portion
22 Frame portion
23 Inner circumferential surface
24 Outer circumferential surface
30A, 30B, 30C Supporting part
40A, 40B Driving part
41 Piezoelectric element
42 Resonance part
42a Body portion
42b Arm portion
42c Energization portion
42d Protruding portion
43 Electrode part
44 Power transmission part
44a Contact surface
45 Accommodating portion
46 Communication portion
50 Board part
51 FPC
52 Driver IC
54A, 54B Position detection sensor
301 Opening portion
501 Image sensor board
502 Image capturing element
503 Control part
R Conductive resin

1. A driving device, comprising:
a piezoelectric element that vibrates under application of a voltage;
a resonance part that resonates with a vibration of the piezoelectric element and moves a moving member in contact with the resonance part; and
a conductive resin that fixes the piezoelectric element to the resonance part, wherein
the resonance part includes an accommodating portion capable of accommodating the conductive resin.

2. The driving device according to claim 1, wherein
the resonance part includes a communication portion that communicates between the accommodating portion and a space outside a region where the piezoelectric element is fixed.

3. The driving device according to claim 2, wherein
the communication portion extends from the accommodating portion to an end portion of the resonance part.

4. The driving device according to claim 1, wherein
the accommodating portion includes an inner circumferential surface having a curved surface shape.

5. The driving device according to claim 1, further comprising:
an electrode part for applying a voltage to the piezoelectric element, wherein
the electrode part is connected to a side of the piezoelectric element opposite to a side at which the piezoelectric element is fixed to the resonance part.

6. An optical element driving device, comprising:
a holding part capable of holding an optical element;
a base part that accommodates the holding part such that the holding part is movable in an optical-path direction of the optical element; and
the driving device according to claim 1 configured to drive the holding part.

7. A camera module, comprising:
the optical element driving device according to claim 6; and
an image capturing part configured to capture a subject image using the optical element.

8. A camera-mounted device that is an information device or a transporting device, the camera-mounted device comprising:
the camera module according to claim 7; and
an image processing part configured to process image information obtained by the camera module.
